(19) United States
(12) Patent Application Publication
(10) Pub. No.: US 2009/0128535 A1
(43) Pub. Date: May 21, 2009

(54) LOW POWER SOURCE DRIVING DEVICE

(76) Inventor: Cheng-Chung YEH, Taipei City (TW)

Correspondence Address: Joe McKinney Muncy, PO Box 1364, Fairfax, VA, 22038-1364, US

(21) Appl. No.: 11/944,347

(22) Filed: Nov. 21, 2007

(51) Int. Cl. G09G 5/00; G09G 3/36

(52) U.S. Cl. 345/211; 345/87

(57) ABSTRACT

A low power source driving device adopted for use on liquid crystal drivers includes a time series controlled digital circuit to generate different digital signal combinations and a dynamically regulated source driver bias circuit to regulate by stages bias currents of source drivers according to the digital signal combinations so that output can reach a Gamma potential while power consumption is reduced at the same time. Increasing the stage number of the bias currents can further reduce power consumption.

### FIELD OF THE INVENTION

The present invention relates to a source driving device and particularly to a source driving device that regulates bias current of a source driver by stages to deliver output at Gamma potential and reduce power consumption at the same time.

### BACKGROUND OF THE INVENTION

Small and medium size liquid crystal displays (LCDs) are widely used on various types of handheld electronic products, such as personal digital assistants (PDAs) and handsets. As the development of the handheld electronic products advances, demands for larger LCDs increases. The duration of the battery becomes more important. Power consumption is an important yardstick of the handheld electronic products. A lower power consumption means that the battery has a longer duration. To reduce the power consumption of internal elements of the handheld electronic products can directly and effectively extend the duration of the battery.

On LCD driving devices, there are two main driving elements: a source driver to drive the horizontal axis and a gate driver to drive the vertical axis. The present prevailing trend of thin-film transistor LCD (TFT-LCD) manufacturing technique increasingly focuses on higher resolution and larger size, element structure also is more precise and complex. A display panel, in addition to data lines and gate lines that are laid horizontally and vertically, also includes other complicated elements such as TFTs and common lines.

Single chip liquid crystal driver is a commonly used electronic element in the handheld electronic products. Its power consumption is a significant portion in the handheld electronic product. Hence to reduce the power consumption of the single chip liquid crystal driver is an important issue hotly pursued in the industry. Industry analyses indicate that power consumption of the source driver takes more than 50% of the total power consumption of the conventional liquid crystal driver.

Refer to FIGS. 1 and 2 for a conventional liquid crystal driver and the driving method thereof. The liquid crystal driver 10, in order to output a precise analog Gamma potential within a gate line time period T_{gate} (the time of one gate line), provides a sufficient and steady bias current I_{source}_{_{—}}_{bias} to a source driver 11 so that the voltage V_{source}_{_{—}}_{channel} of a source channel loading 22 on a data line 21 of a LCD panel 20 can rapidly rise or drop to a designated Gamma potential at a presumed required time period T_{rf}_{_{—}}_{source}. Moreover, in the gate line time period T_{gate} an adequate response time is spared to a TFT cell loading 23 so that the potential V_{TFT} of a storage capacitor C_{TFT} in the TFT cell loading 23 also rises or drops to the designated Gamma potential at a presumed required time period T_{rf}_{_{—}}_{TFT}. An equation can be established as follow:

T_{gate}=T_{rf}_{_{—}}_{source}+T_{rf}_{_{—}}_{TFT}

To deliver the precise analog Gamma potential within the gate line time period T_{gate} is the function of the source driver 11. However, as the size of the LCD panel 20 increases each gate line time period T_{gate} is shorter. Hence the current driving power output from the source driver 11 must increase to mate the shortened gate line time period T_{gate}. Traditionally, increasing the bias current I_{source}_{_{—}}_{bias} of the source driver 11 can effectively and directly increase the current driving power. But increasing the bias current I_{source}_{_{—}}_{bias} of the source driver 11 also makes power consumption of the liquid crystal driver 10 increasing drastically.

In short, the conventional driving device and method have the following disadvantages:

1. In the time period T_{rf}_{_{—}}_{TFT} spared for the storage capacitor C_{TFT} of the TFT cell loading 23 to allow the potential V_{TFT} thereof to rise or drop to the designated Gamma potential, the source driver 11 is given the bias current I_{source}_{_{—}}_{bias} same as in the time period T_{rf source}. But the voltage V_{source}_{_{—}}_{channel} of the source channel loading 22 of the LCD panel 20 has already reached the designated Gamma potential, such as 99% of V_{gamma}. With the source driver 11 still be input with the constant bias current I_{source}_{_{—}}_{bias}, power consumption occurs.

2. In the time period T_{rf}_{_{—}}_{source} for the voltage of the source channel to rise or drop to the designated Gamma potential, the source driver 11 is given a constant bias current I_{source}_{_{—}}_{bias}, referring to FIG. 2. But only in the earlier ¼ time period of T_{rf}_{_{—}}_{source} a drastic and temporary fluctuation of the voltage V_{source}_{_{—}}_{channel} of the source channel loading 22 takes place. In the rest time period of T_{rf}_{_{—}}_{source} and T_{rf}_{_{—}}_{TFT}, input of the constant bias current I_{source}_{_{—}}_{bias} only creates power consumption.

### SUMMARY OF THE INVENTION

In order to solve the aforesaid disadvantages, the primary object of the present invention is to deliver output at Gamma potential and also reduce power consumption of a liquid crystal driver at the same time.

To achieve the foregoing object the present invention provides a lower power source driver technique for liquid crystal drivers that regulates by stages bias current of a source driver so that Gamma potential can be output while power consumption is reduced at the same time. As the number of stages increases for the bias current of the source driver power consumption can be further reduced.

The invention provides a low power source driving device adopted for use on liquid crystal drivers to drive a source channel loading and a TFT cell loading on a data line of a LCD panel. The source driving device includes a time series controlled digital circuit to generate different digital signal combinations within a gate line time period according to loading requirements of the LCD panel with the combinations of the digital signals at only one digital signal logic level 1 at one time; a dynamically regulated source driver bias circuit to generate bias currents of different analog levels according to the digital signal combinations, and a plurality of source drivers to generate corresponding output driving power through the bias currents so that the LCD panel loading can rise or drops to a designated Gamma potential within the gate line time period.

The digital signal combinations set forth above includes at least two digital signal combinations. The dynamically regulated source driver bias circuit generates at least two bias currents of analog levels according to the digital signal combinations. A normal bias current is generate at the start of each gate line time period so that the source drivers generate sufficient driving power to make the loading voltage of the LCD panel to rise or drop to the designated Gamma potential. In the rest time of the gate line time period at least one lower bias current is generated so that the source drivers can generate steady driving power. When the time is closer to the end of each gate line time period the bias current generated by the dynamically regulated source driver bias circuit is smaller.

The invention provides another embodiment which includes a plurality of Gamma drivers and a plurality of digital analog converters to replace the source drivers. The number of the Gamma drivers mates the grey scale number to be presented on the LCD panel. Through the bias current previously discussed grey scale voltages to be presented are generated. Then the analog digital converters output a required grey scale voltage to the source channel loading so that the load of the LCD panel can rise or drop to the designated Gamma potential within the gate line time period.

The Gamma drivers are further composed of a plurality of Gamma pre-drivers and resistors located between the Gamma pre-drivers to produce voltage components to generate the grey scale voltage through the bias current. The invention provides many advantages, such as able to deliver output at the Gamma potential and also reduce power consumption at the same time by regulating the bias current of the source drivers by stages. The source drivers according to the invention can reduce power consumption by 20%. As the number of the stages of the bias current increases the power consumption can be further reduced.

The foregoing, as well as additional objects, features and advantages of the invention will be more readily apparent from the following detailed description, which proceeds with reference to the accompanying drawings. The embodiments discussed below serve only for illustrative purpose and are not the limitation of the invention.

### BRIEF DESCRIPTION OF THE DRAWINGS

FIG. 1 is a schematic view of a conventional source driver driving an LCD loading.

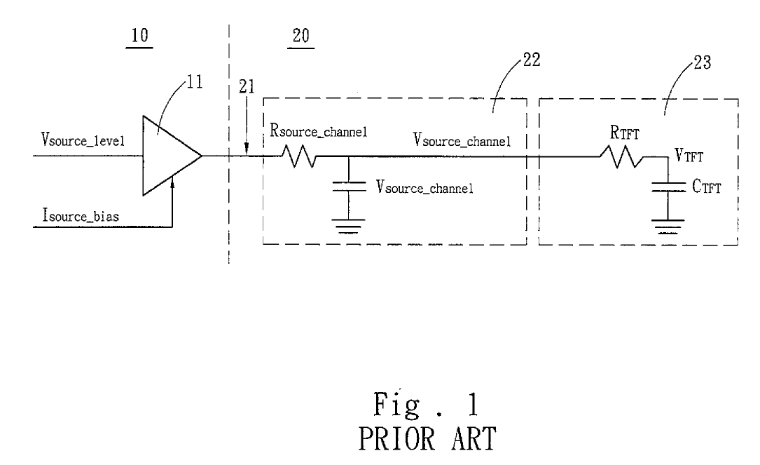

FIG. 2 is a waveform chart of the voltage of the source channel loading and TFT cell loading, and the bias current of the source driver according to FIG. 1.

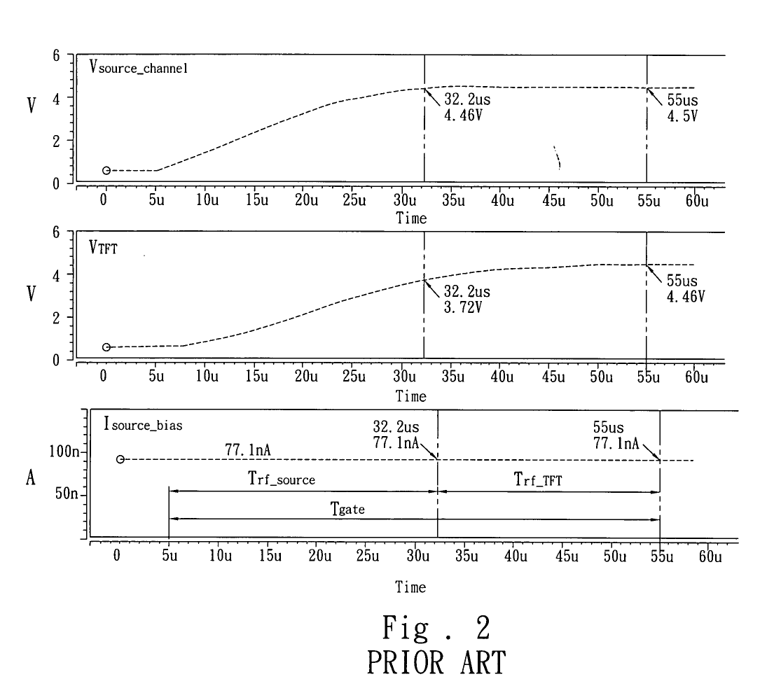

FIG. 3 is a schematic view of a source driver driving a LCD loading according to the invention.

FIG. 4 is a schematic view of a first embodiment of the invention.

FIG. 5 is a waveform chart of the voltage of the source channel loading and TFT cell loading, and the bias current of the source driver according to FIG. 4.

FIG. 6 is a schematic view of a second embodiment of the invention.

FIG. 7 is a waveform chart of the voltage of the source channel loading and TFT cell loading, and the bias current of the source driver according to FIG. 6,

FIG. 8 is a schematic view of a third embodiment of the invention.

FIG. 9 is a schematic view of a fourth embodiment of the invention.

### DETAILED DESCRIPTION OF THE PREFERRED EMBODIMENTS

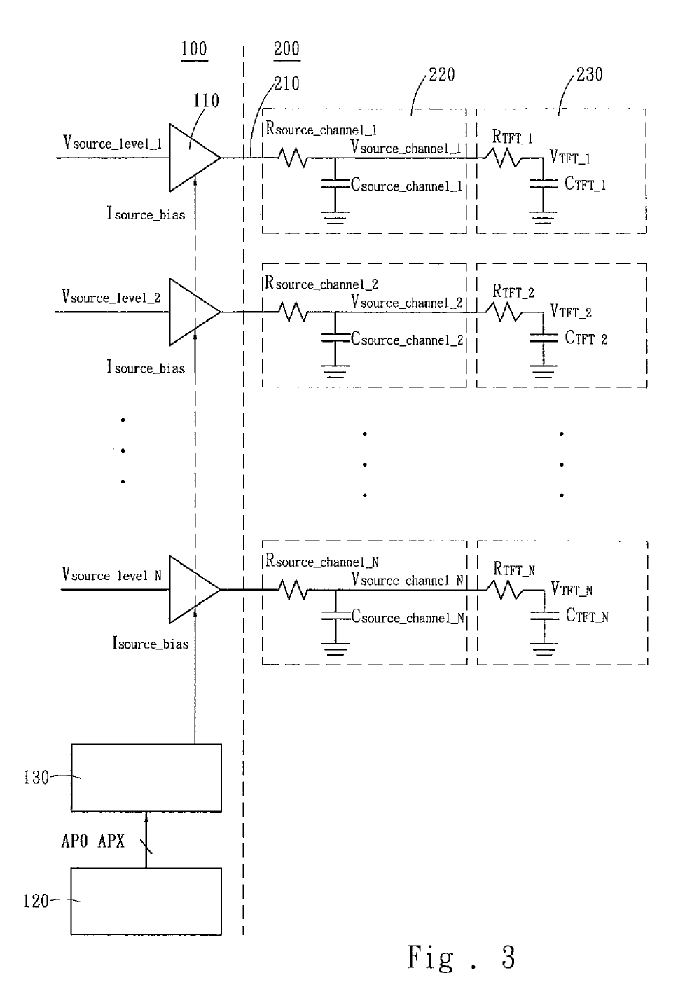

Please refer to FIG. 3. The invention provides a low power driving device to be used on a liquid crystal driver 100 to drive a source channel loading 220 and a TFT cell loading 230 on a data line 210 of an LCD panel 200. It includes a time series controlled digital circuit 120 to generate different digital signal combinations AP0-APX within a gate line time period T_{gate} according to loading requirements of the LCD panel 200. These digital signal combinations AP0-APX have only one digital signal logic level 1 at one time. A dynamically regulated source driver bias circuit 130 is provided to generate bias currents I_{source}_{_{—}}_{bias} of different analog levels according to the digital signal combinations AP0-APX. When the logic level of the digital signal AP0 is 1, it represents that a maximum bias current I_{source}_{_{—}}_{bias} of the dynamically regulated source driver bias circuit 130 is selected. When the logic level of the digital signal APX is 1, it represents that a minimum bias current I_{source}_{_{—}}_{bias} of the dynamically regulated source driver bias circuit 130 is selected. A plurality of source drivers 110 also is included. Through the bias currents I_{source}_{_{—}}_{bias}, a source potential Vsource_level_{—}1 input to the sources drivers 110 can be controlled to generate a corresponding output driving power so that the source channel loading 220 and the TFT cell loading 230 of the LCD panel 200 can rise or drop to a designated Gamma potential within one gate line time period T_{gate}.

To facilitate discussion of the invention, the source drivers 110 have output ends connecting to equivalent source channel resistors R_{source}_{_{—}}_{channel}_{_{—}}₁-R_{source}_{_{—}}_{channel}_{_{—}}_{N} and equivalent source channel capacitors C_{source}_{_{—}}_{channel}_{_{—}}₁-C_{source}_{_{—}}_{channel}_{_{—}}_{N} of the source channel loading 220 of the LCD panel 200 and equivalent cell resistors R_{TFT}_{_{—}}₁-R_{TFT}_{_{—}}_{N} and equivalent storage capacitors C_{TFT}_{_{—}}₁-C_{TFT}_{_{—}}_{N} of the TFT cell loading 230.

The digital signal combinations AP0-APX include at least two digital signal combinations. The dynamically regulated source driver bias circuit 130 generates at least two bias currents I_{source}_{_{—}}_{bias} of analog levels according to the digital signal combinations AP0-APX. At the start of each gate line time period T_{gate}, a normal bias current I_{source}_{_{—}}_{bias} is generated so that the source drivers 110 can generate enough driving power to make the voltage V_{source}_{_{—}}_{channel} of the source channel loading 220 of the LCD panel 200 to rise or drop at the designated Gamma potential. In the rest of the gate line time period T_{gate} at least a lower bias current I_{source}_{_{—}}_{bias} is generated so that the source divers 110 can generate stable driving power. When the time is closer the end of each gate line time period T_{gate}, the bias current I_{source}_{_{—}}_{bias} generated by the dynamically regulated source driver bias circuit 130 is smaller.

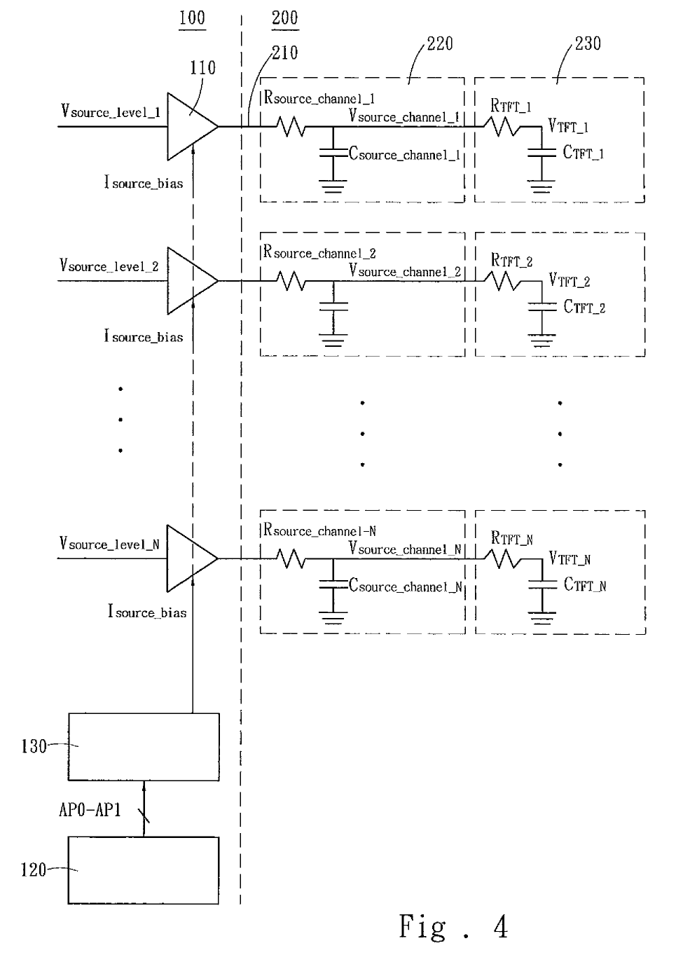

Refer to FIG. 4 for a first embodiment of the invention.

Within one gate line time period T_{gate} the time series controlled digital circuit 120 generates two digital signal combinations AP0-AP1. In this embodiment, within one gate line time period T_{gate} the bias currents I_{source}_{_{—}}_{bias} of the source drivers 110 are divided into two portions so that the voltage V_{source}_{_{—}}_{channel} of the source channel loading 220 on the data line 210 rapidly rises or drops to the designated Gamma potential at a required time period T_{rf}_{_{—}}_{source} and the potential V_{TFT} of the storage capacitor C_{TFT} in the TFT cell loading 230 rises or drops to the designated Gamma potential at a required time period T_{rf}_{_{—}}_{TFT}. In the time period of T_{rf}_{_{—}}_{source} the time series controlled digital circuit 120 makes the digital signal AP0 at logic level 1 so that the dynamically regulated source driver bias circuit 130 generates a greater bias current I_{source}_{_{—}}_{bias}(T_{AP0}) to allow the source drivers 110 to generate sufficient driving power and consequently make the voltage V_{source}_{_{—}}_{channel} of the source channel loading 220 of the LCD panel 200 to rise or drop to the designated Gamma potential, such as 99% of the Gamma potential.

In the rest time of T_{rf}_{_{—}}_{TFT}, the time series controlled digital circuit 120 makes the digital signal AP1 at logic level 1 so that the dynamically regulated source driver bias circuit 130 generates a lower bias current I_{source}_{_{—}}_{bias}(I_{AP1}), and the source drivers 110 generate steady driving power to make the potential V_{TFT} of the TFT cell loading 230 to rise or drop to the designated Gamma potential, such as 99% of the Gamma potential.

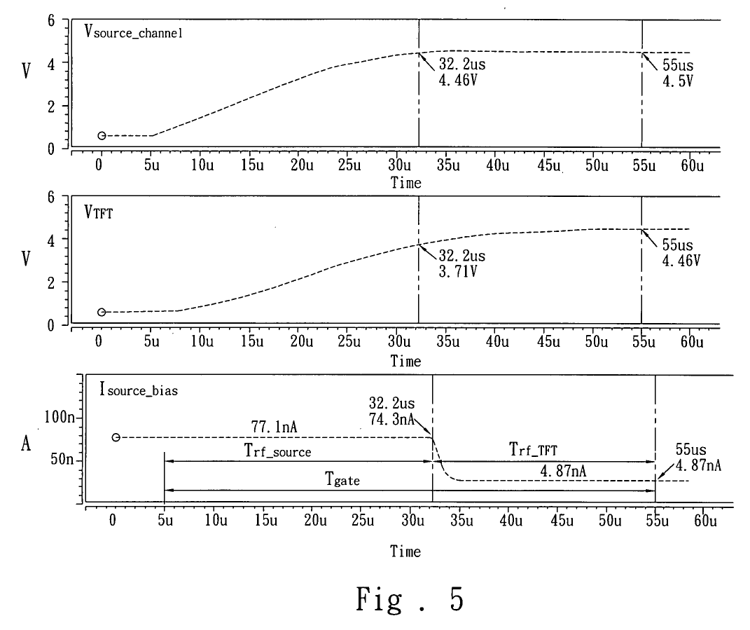

The waveforms of the voltage V_{source}_{_{—}}_{channel} and V_{TFT} of the source channel loading 220 and TFT cell loading 230, and the bias current I_{source}_{_{—}}_{bias} of the source drivers 110 are shown in FIG. 5. In this embodiment comparison of the power consumption (or average current) P1 of the source drivers 110 and the power consumption (or average current) of the conventional source driver 11 can be represented by an equation as follow (approximately):

P1/P0=(I_{AP0}×T_{rf}_{_{—}}_{source}+I_{AP1}×T_{rf}_{_{—}}_{TFT})/(I_{AP0}×T_{gate}).

For instance, if R_{source}_{_{—}}_{channel} is 8 KOhm, C_{source}_{_{—}}_{channel} is 12 pF, R_{TFT} is 15 MOhm, C_{TFT} is 0.5 pF, and one gate line time period T_{gate} is 50 uS, to get the source voltage to rise from 0.5V to 4.5V, I_{AP0} is 77.1 nA, Trf_source is 27.2 uS, I_{AP1} is 48.7 nA, and T_{rf}_{_{—}}_{TFT} is 22.8 uS, then P1/P0=83.2% according to the equation set forth above.

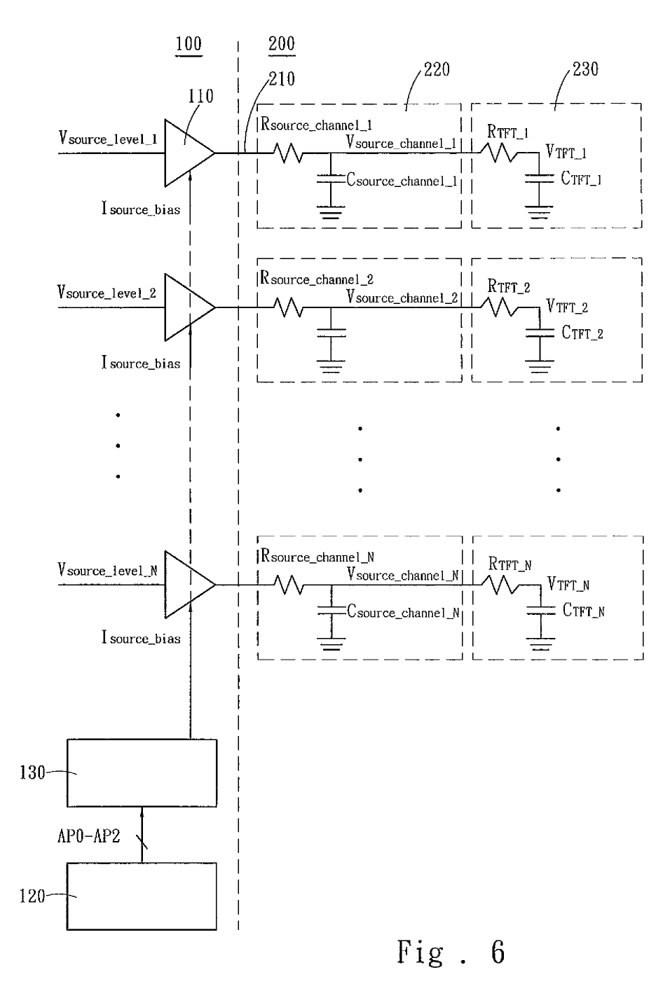

Refer to FIG. 6 for a second embodiment of the invention. Within one gate line time period T_{gate} the time series controlled digital circuit 120 generates three digital signal combinations AP0-AP2. In this embodiment, within one gate line time period T_{gate} the bias currents I_{source}_{_{—}}_{bias} of the source drivers 110 are divided into three portions so that the voltage V_{source}_{_{—}}_{channel} of the source channel loading 220 rises or drops to the designated Gamma potential at a time period T_{rf}_{_{—}}_{source} which is divided into ⅗×T_{rf}_{_{—}}_{source} and ⅖×T_{rf}_{_{—}}_{source}, and the potential V_{TFT} of the storage capacitor C_{TFT} in the TFT cell loading 230 rises or drops to the designated Gamma potential at a required time period T_{rf}_{_{—}}_{TFT}. In the time period of ⅗×T_{rf}_{_{—}}_{source} the time series controlled digital circuit 120 makes the digital signal AP0 at logic level 1 so that the dynamically regulated source driver bias circuit 130 generates a greater bias current I_{source}_{_{—}}_{bias} (I_{AP0}) to allow the source drivers 110 to generate sufficient driving power and consequently make the voltage V_{source}_{_{—}}_{channel} of the source channel loading 220 of the LCD panel 200 to rise or drop to the designated Gamma potential, such as 81.2% of the Gamma potential. In the ⅖×T_{rf}_{_{—}}_{source} time period, the time series controlled digital circuit 120 makes the digital signal AP1 at logic level 1 so that the dynamically regulated source driver bias circuit 130 generates a second greater bias current I_{source}_{_{—}}_{bias} (I_{AP1}) to allow the voltage V_{source}_{_{—}}_{channel} of the source channel loading 220 of the LCD panel 200 to rise or drop to the designated Gamma potential, such as 99% of the Gamma potential.

In the rest time of T_{rf}_{_{—}}_{TFT} the time series controlled digital circuit 120 makes the digital signal AP2 at logic level 1 so that the dynamically regulated source driver bias circuit 130 generates a lower bias current Isource_bias (I_{AP2}), and the source drivers 110 generate steady driving power to make the potential V_{TFT} of the TFT cell loading 230 to rise or drop to the designated Gamma potential such as 99% of the Gamma potential.

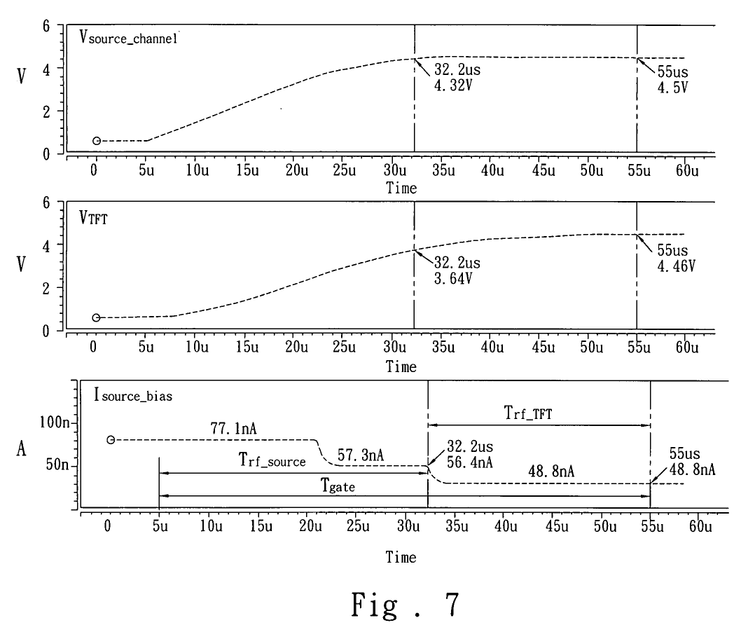

The waveforms of the voltage V_{source}_{_{—}}_{channel} and V_{TFT} of the source channel loading 220 and TFT cell loading 230, and the waveform of the bias current I_{source}_{_{—}}_{bias} of the source drivers 110 are shown in FIG. 7. In this embodiment comparison of the power consumption (or average current) P2 of the source drivers 110 and the power consumption (or average current) of the conventional source driver 11 can be represented by an equation as follow (approximately): P2/P0=(I_{AP0}×(⅗)×T_{rf}_{_{—}}_{source}+I_{AP1}×(⅖)×T_{rf}_{_{—}}_{source}+I_{AP2}×T_{rf}_{_{—}}_{TFT})/(I_{AP0}×T_{gate})

For instance, if R_{source}_{_{—}}_{channel} is 8 KOhm, C_{source}_{_{—}}_{channel} is 12 pF, R_{TFT} is 15 MOhm, C_{TFT} is 0.5 pF, and a gate line time period T_{gate} is 50 uS, to get the source voltage to rise from 0.5V to 4.5V I_{AP0} is 77.1 nA, Trf_source is 27.2 uS, I_{AP1} is 57.3 nA, I_{AP2} is 48.8 nA, T_{rf}_{_{—}}_{source} is 27.2 US, I_{AP1} is 57.3 nA, I_{AP2} is 48.8 nA, and T_{rf}_{_{—}}_{TFT} is 22.8 uS, then P2/P0=77.9% according to the equation set forth above.

By the same token, within one gate line time period T_{gate}, the invention can divide the bias current I_{source}_{_{—}}_{bias} of the source drivers 110 into several portions (as shown in FIG. 3). At the start of one gate line time period T_{gate}, the time series controlled digital circuit 120 makes the digital signal AP0 at logic level 1 so that the dynamically regulated source driver bias circuit 130 generates a higher bias current I_{source}_{_{—}}_{bias} to allow the source drivers 110 to generate sufficient power to make the voltage V_{source}_{_{—}}_{channel} of the source channel loading 220 of the LCD panel 200 to rise or drop to the designated Gamma potential. At the end of the one gate line time period T_{gate}, the time series controlled digital circuit 120 makes the digital signal APX at logic level 1 so that the dynamically regulated source driver bias circuit 130 generates a lowest bias current I_{source}_{_{—}}_{bias}, consequently the source drivers 110 generate steady driving power to make the potential V_{TFT} of the TFT cell loading 230 to rise or drop to the designated Gamma potential.

The embodiments previously discussed have each source channel to own its source driver 110. Without departing the spirit and scopes of the invention, another embodiment may be established that has an assembly consisting of a plurality of Gamma drivers and a plurality of digital analog converters to substitute the source drivers 110, as shown in a third embodiment discussed below. Unlike the previous embodiments, each source channel does not have its own source driver 110. The adopted approach is: every same grey scale source channel is driven by a same source driver. Such a source driver is called Gamma driver.

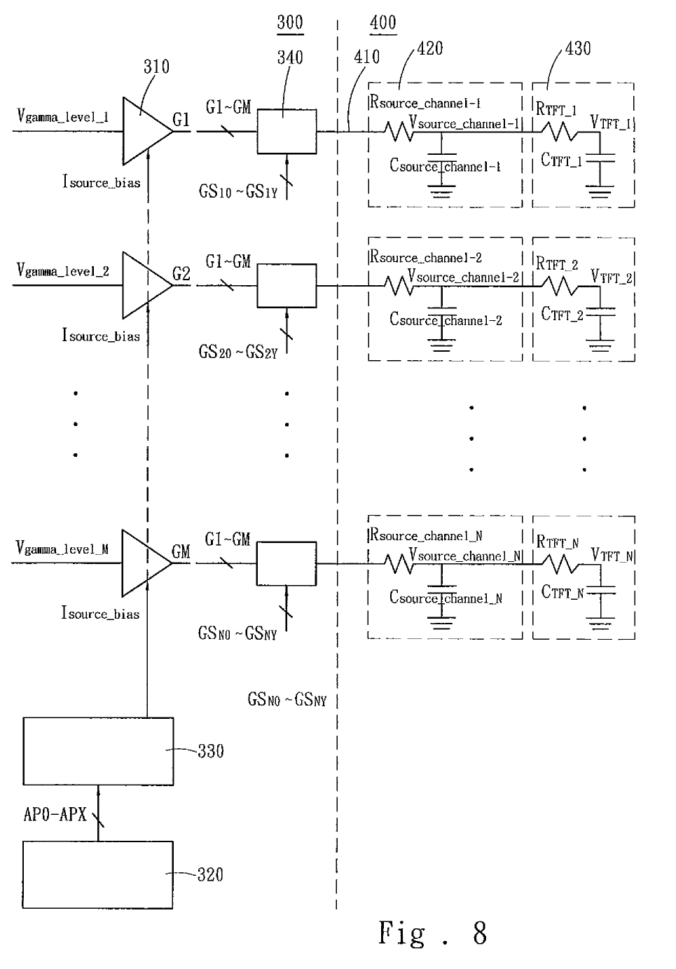

Referring to FIG. 8, this embodiment provides a driving device for a liquid crystal driver 300 to drive a source channel loading 420 and a TFT cell loading 430 on a data line 410 of a LCD panel 400. It includes a time series controlled digital circuit 320, a dynamically regulated source driver bias circuit 330 and a plurality of Gamma drivers 310. The number of the Gamma drivers 310 is same as the number of grey scales to be presented. For instance, M Gamma drivers 310 are provided for M grey scales. The Gamma drivers 310 are controlled by the bias current I_{source}_{_{—}}_{bias} previously discussed so that input Gamma potentials V_{gamma}_{_{—}}ₗₑᵥₑₗ_{_{—}}₁-V_{gamma}_{_{—}}ₗₑᵥₑₗ_{_{—}}_{M} correspond to output grey scale voltages G1-GM.

The grey scale voltages G1-GM are transmitted through a plurality of digital analog converters 340 which serve as source drivers according to digital selection data (GS₀₀-GS_{0Y}, . . . GS_{N0}-GS_{NY}) so that the voltage of the loading of the LCD panel 400 (source channel loading 420 and TFT cell loading 430) can rise or drop within one gate line time period T_{gate} to a designated Gamma potential.

The time series controlled digital circuit 320 meets the loading requirement of the LCD panel 400 in one gate line time period T_{gate} to generate different digital signal combinations AP0-APX. The digital signal combinations AP0-APX have only one digital signal logic level 1 at one time. The dynamically regulated source driver bias circuit 330 generates bias currents I_{source}_{_{—}}_{bias} of different analog levels according to the digital signal combinations AP0-APX. When the digital signal AP0 is at logic level 1, it represents that a maximum bias current Isource_bias of the dynamically regulated source driver circuit 330 is selected.

This embodiment functions like the one previously discussed. In one gate line time period T_{gate}, the bias currents I_{source}_{_{—}}_{bias} of the Gamma drivers 310 are divided into several portions. At the start of one gate line time period T_{gate}, the time series controlled digital circuit 320 makes the digital signal AP0 at the logic level 1 so that the dynamically regulated source driver bias circuit 330 generates a higher bias current I_{source}_{_{—}}_{bias} to make each Gamma driver 310 to generate sufficient driving power. Consequently the voltage V_{source}_{_{—}}_{channel} of the source channel loading 420 of the LCD panel 400 rises or drops to a designated Gamma potential. At the end of one gate line time period T_{gate}, the time series controlled digital circuit 320 makes the digital signal APX at the logic level 1 so that the dynamically regulated source driver bias circuit 330 generates a lowest bias current I_{source}_{_{—}}_{bias}, and each Gamma driver 310 generates steady driving power. Consequently the potential V_{TFT} of the TFT cell loading 430 rises or drops to the designated Gamma potential.

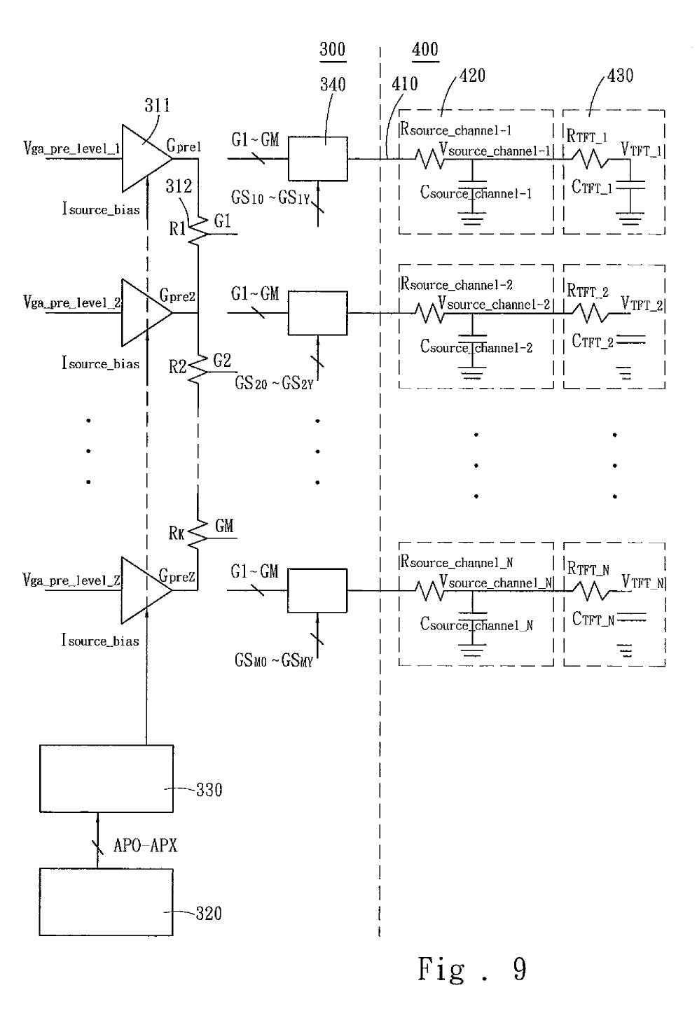

Refer to FIG. 9 for a fourth embodiment of the invention. It differs from the previous embodiment by having a plurality of Gamma pre-drivers 311 bridged by resistors 312 (R₁-Rₖ) on each Gamma driver 310. Namely each source channel of the same grey scale is driven by a resistor voltage divider and a source driver.

The voltage driving point is generated by the voltage component of the Gamma pre-drivers 311 and resistors 312. The number of the voltage driving point is same as the number of grey scale to be presented. The number of the Gamma pre-drivers 311 (1-Z) and the size and number of the resistors 312 of the voltage component depend on engineering applications. The Gamma pre-drivers 311 are controlled by the bias current I_{source}_{_{—}}_{bias} so that inputs of Gamma pre-voltage levels V_{ga}_{_{—}}ₚᵣₑ_{_{—}}level_{_{—}}₁-V_{ga}_{_{—}}ₚᵣₑ_{_{—}}ₗₑᵥₑₗ_{_{—}}_{Z} generate outputs of Gamma pre-voltage levels Gₚᵣₑ₁-G_{prez}. Through the voltage components of the resistors 312 required grey scale voltages G1-GM are generated.

The grey scale voltages G1-GM are transmitted through a plurality of digital analog converters 340 which serve as source drivers according to digital selected data (GS₀₀-GS_{0Y}, . . . GS_{N0}-GS_{NY}) so that the loading of the LCD panel 400 can rise or drop to a designated Gamma potential within one gate line time period T_{gate}.

The time series controlled digital circuit 320 meets the loading requirement of the LCD panel 400 in one gate line time period T_{gate} to generate different digital signal combinations AP0-APX. The digital signal combinations AP0-APX have only one digital signal logic level 1 at one time. The dynamically regulated source driver bias circuit 330 generates bias currents I_{source}_{_{—}}_{bias} of different analog levels according to the digital signal combinations AP0-APX. When the digital signal AP0 is at logic level 1, it represents that a maximum bias current Isource_bias of the dynamically regulated source driver circuit 330 is selected.

This embodiment functions as follow: in one gate line time period T_{gate}, the bias currents I_{source}_{_{—}}_{bias} of the Gamma pre-drivers 311 are divided into several portions. At the start of one gate line time period T_{gate}, the time series controlled digital circuit 320 makes the digital signal AP0 at the logic level 1 so that the dynamically regulated source driver bias circuit 330 generates a higher bias current I_{source}_{_{—}}_{bias} to make each Gamma pre-driver 311 to generate sufficient driving power. Consequently the voltage V_{source}_{_{—}}_{channel} of the source channel loading 420 of the LCD panel 400 rises or drops to a designated Gamma potential. At the end of one gate line time period T_{gate}, the time series controlled digital circuit 320 makes the digital signal APX at the logic level 1 so that the dynamically regulated source driver bias circuit 330 generates a lowest bias current I_{source}_{_{—}}_{bias}, and each Gamma pre-driver 311 generates steady driving power. Consequently the potential V_{TFT} of the TFT cell loading 430 rises or drops to the designated Gamma potential.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A low power source driving device to drive an LCD panel loading, comprising:
a time series controlled digital circuit to generate different digital signal combinations within a gate line time period that have only one digital signal at logic level 1 at one time;
a dynamically regulated source driver bias circuit to generate bias currents of different analog levels according to the digital signal combinations; and
a plurality of source drivers controlled by the bias currents to generate corresponding driving power to allow the LCD panel loading to rise or drop within the gate line time period to a designated Gamma potential.

2. The low power source driving device of claim 1, wherein the digital signal combinations include at least two digital signal combinations and the dynamically regulated source driver bias circuit generates at least two bias currents of analog levels according to the digital signal combinations; a normal bias current being generated at the start of each gate line time period to allow the source drivers to generate sufficient driving power to make the LCD panel loading to rise or drop to the designated Gamma potential, and a lower bias current being generated in the rest of the gate line time period to make the source drivers to generate steady driving power.

3. The low power source driving device of claim 2, wherein the dynamically regulated source driver bias circuit generates a smaller bias current when the gate line time period approaches the end thereof.

4. A low power source driving device to drive a LCD panel loading, comprising:
a time series controlled digital circuit to generate different digital signal combinations within a gate line time period that have only one digital signal at logic level 1 at one time;
a dynamically regulated source driver bias circuit to generate bias currents of different analog levels according to the digital signal combinations;
a plurality of Gamma drivers controlled by the bias currents to generate grey scale voltages to be presented; and
a plurality of digital analog converters to output the required grey scale voltages to allow the LCD panel loading to rise or drop within the gate line time period to a designated Gamma potential.

5. The low power source driving device of claim 4, wherein the digital signal combinations include at least two digital signal combinations and the dynamically regulated source driver bias circuit generates at least two bias currents of analog levels according to the digital signal combinations; a normal bias current being generated at the start of the gate line time period to allow the Gamma drivers to generate sufficient driving power to make the LCD panel loading to rise or drop to the designated Gamma potential, and a lower bias current being generated in the rest of the gate line time period to make the Gamma drivers to generate steady driving power.

6. The low power source driving device of claim 5, wherein the dynamically regulated source driver bias circuit generates a smaller bias current when the gate line time period approaches the end thereof.

7. The low power source driving device of claim 4, wherein the Gamma drivers include a plurality of Gamma pre-drivers and resistors which bridge the Gamma pre-drivers that are controlled by the bias currents to generate voltage components to present desired grey scale voltages.

8. The low power source driving device of claim 7, wherein the digital signal combinations include at least two digital signal combinations and the dynamically regulated source driver bias circuit generates at least two bias currents of analog levels according to the digital signal combinations; a normal bias current being generated at the start of the gate line time period to allow the Gamma pre-drivers to generate sufficient driving power to make the LCD panel loading to rise or drop to the designated Gamma potential, and a lower bias current being generated in the rest of the gate line time period to make the Gamma pre-drivers to generate steady driving power.

9. The low power source driving device of claim 7, wherein the dynamically regulated source driver bias circuit generates a smaller bias current when the gate line time period approaches the end thereof.
